(19) United States
(12) Patent Application Publication
(10) Pub. No.: US 2008/0052799 A1
(43) Pub. Date: Mar. 6, 2008

(54) Hand Protector For Kitchen Work

(76) Inventor: Dae Kyu Yoo, Gyeonggi-do (KR)

Correspondence Address: DICKSTEIN SHAPIRO LLP, 1825 EYE STREET NW, Washington, DC, 20006-5403, US

(21) Appl. No.: 11/596,767

(22) PCT Filed: May 4, 2005
(86) PCT No.: PCT/KR05/01293

§ 371 Date: Nov. 16, 2006

(30) Foreign Application Priority Data
May 19, 2004 (KR) 10-2004-0035633
Jul. 14, 2004 (KR) 20-2004-0020053
Nov. 12, 2004 (KR) 20-2004-0032071
Feb. 4, 2005 (KR) 10-2005-0010504

(51) Int. Cl. A47J 43/28; F41H 1/00

(52) U.S. Cl. 2/16; 2/161.8; 2/167; 2/169; 2/2.5

(57) ABSTRACT

Disclosed herein is a hand protector for kitchen work. The hand protector is worn on the back of the hand and the fingers, thus protecting the user's hand from the blade of a kitchen knife, and ensuring unrestricted movement of his or her fingers while wearing the hand protector. Thus, this invention protects a user from a cut wound during a cooking operation, thus relaxing the user and allowing him or her to cook food in a pleasant frame of mind. Further, this invention ensures unrestricted movement of the user's fingers and prevents the user from being injured, thus allowing the user to cut at a fast speed and allowing the cooking operation to be more rapidly executed.

### TECHNICAL FIELD

The present invention relates, in general, to hand protectors for kitchen work and, more particularly, to a hand protector for kitchen work intended to protect the fingers, back of the hand, and surrounding area from the blade of a kitchen knife, when a person cuts food with the kitchen knife in a kitchen, in addition to affording unrestricted hand movement.

### BACKGROUND ART

Generally, when a person cuts food ingredients with a kitchen knife for preparation of food, the food ingredients are held by one hand, and the kitchen knife is held by the other hand to cut the food ingredients.

### DISCLOSURE

### Technical Problem

Since food ingredients are usually held with one hand during cutting, a slight careless handling may cause a cut wound to a user's finger from a blade of a kitchen knife.

Such an accident mainly occurs in kitchens of restaurants where kitchen knives are used frequently. Further, those who are not skilled in cutting may be frequently injured by the knives.

The blade of a kitchen knife is sharp. Further, a user must exert a strong force to cut food ingredients, thus making the user vulnerable to a cut wound. Unfortunately, when a wound is serious, a finger joint may be severed.

Hence, when cutting with a kitchen knife, a user must slowly cut food ingredients while concentrating on cutting so that the user's finger is not cut. Thus, it may take a long time to prepare food. Further, the fear of cutting causes a person to dislike cooking food, in addition to leading to a feeling of uneasiness.

Accordingly, the present invention has been made keeping in mind the above problems, and an object of the present invention is to provide a hand protector for kitchen work which prevents the fingers or the back of the hand from being cut while cutting with a kitchen knife, and allows unrestricted hand movement, thus allowing the user to easily grasp and hold food ingredients with his or her hand.

### Technical Solution

In order to accomplish the above object, the present invention provides a hand protector for kitchen work including an outer hand-back covering part having a shape corresponding to a back of a hand, a plurality of outer finger covering parts having shapes corresponding to respective fingers, and an inner unit attached to inner surfaces of the outer hand-back covering part and the outer finger covering parts, the inner unit being constructed so that the fingers may be inserted into the inner unit, and so as to cover the back of the hand.

### ADVANTAGEOUS EFFECTS

According to the present invention, a hand protector for kitchen work is worn on the back of the hand and fingers, thus protecting the user's hand from the blade of a kitchen knife, and ensuring unrestricted movement of his or her fingers, even though he or she wears the hand protector.

Thus, this invention protects a user from a cut wound during a cooking operation, thus relaxing the user, therefore allowing the user to cook food in a pleasant frame of mind. Further, this invention ensures unrestricted movement of the user's fingers, and prevents the user from being injured, thus allowing the user to cut at a fast speed and allowing the cooking operation to be more rapidly executed.

### DESCRIPTION OF DRAWINGS

FIG. 1 is a perspective view showing a hand protector for kitchen work, according to the first embodiment of the present invention;

FIG. 2 is a sectional view showing an important part of FIG. 1;

FIG. 3 is a sectional view showing an inner unit of the hand protector, according to a modification of the first embodiment of this invention, with anti-slip protrusions being formed on a finger insertion part;

FIG. 4 is a front view showing an inner unit of the hand protector, according to another modification of the first embodiment of this invention, with a mesh net being provided on part of the inner unit;

FIG. 5 is a perspective view showing an inner unit of the hand protector, according to a further modification of the first embodiment of this invention, with a mesh net being provided on an entire part of the inner unit;

FIG. 6 is perspective view showing an outer unit of the hand protector, according to a modification of the first embodiment of this invention;

FIG. 7 is a perspective view showing another coupling structure of a band unit of the hand protector, according to the first embodiment of this invention;

FIG. 8 is a sectional view taken along line AA of FIG. 7;

FIG. 9 is a perspective view showing a still another coupling structure of the band unit of the hand protector, according to the first embodiment of this invention;

FIG. 10 is a perspective view showing an inner unit of the hand protector, according to a further modification of the first embodiment of this invention, with reinforcing pieces being attached to a lower surface of the inner unit;

FIG. 11 is a perspective view showing a hand protector for kitchen work according to the second embodiment of the present invention;

FIG. 12 is an exploded perspective view of the hand protector, according to the second embodiment of this invention, the drawing schematically showing the state before outer parts are combined with an inner unit;

FIG. 13 is a rear perspective view of the hand protector, according to this invention;

FIG. 14 is a sectional view schematically showing a combined structure of the hand protector for kitchen work, according to the second embodiment of this invention;

FIG. 15 is a view showing the use of the hand protector, according to the second embodiment of this invention;

FIG. 16 is a plan view showing the use of the hand protector, according to the second embodiment of this invention;

FIG. 17 is a front view showing first and second outer finger covering parts and a first outer joint covering part, according to a modification of the second embodiment of this invention;

FIG. 18 is a perspective view showing a hand protector for kitchen work according to the third embodiment of this invention;

FIG. 19 is a perspective view showing outer parts of FIG. 18 from a different angle;

FIG. 20 is a view showing the use of the hand protector, according to the third embodiment of this invention;

FIG. 21 is a perspective view showing an outer hand-back covering part and outer finger covering parts, according to a modification of this invention;

FIG. 22 is a sectional view showing the combined state of the parts of FIG. 21;

FIG. 23 is a perspective view showing a hand protector for kitchen work; according to the fourth embodiment of the present invention;

FIG. 24 is an exploded perspective view of the hand protector of FIG. 23;

FIG. 25 is a perspective view showing the process of combining first and second cover parts of an inner unit, according to the fourth embodiment of this invention;

FIG. 26 is a perspective view showing a band unit, according to a modification of the fourth embodiment of this invention; and

FIG. 27 is a perspective view showing a second cover part of the inner unit, according to a modification of the fourth embodiment.

*Description of reference characters of important parts*

100: inner unit
110: finger insertion parts of inner unit
112: water drain holes
115: nail insertion parts
122: anti-slip protrusions
125: notches
150: mesh net
200: outer unit
210: outer hand-back covering part
220: outer finger covering parts
215: wrist protecting portion
230: coupling members
300: band unit
322: locking holes
324: locking projection
332, 334: Velcro fastener
342: punch holes
344: fitting tongue
400: reinforcing pieces

### MODE FOR INVENTION

According to the present invention, a hand protector for kitchen work is characterized in that it includes an outer hand-back covering part having a shape corresponding to a back of a hand, a plurality of outer finger covering parts having shapes corresponding to respective fingers, and an inner unit attached to inner surfaces of the outer hand-back covering part and the outer finger covering parts, the inner unit being constructed so that the fingers may be inserted into the inner unit, and so as to cover the back of the hand. The preferred embodiments of this invention will be described below in detail.

### First Embodiment

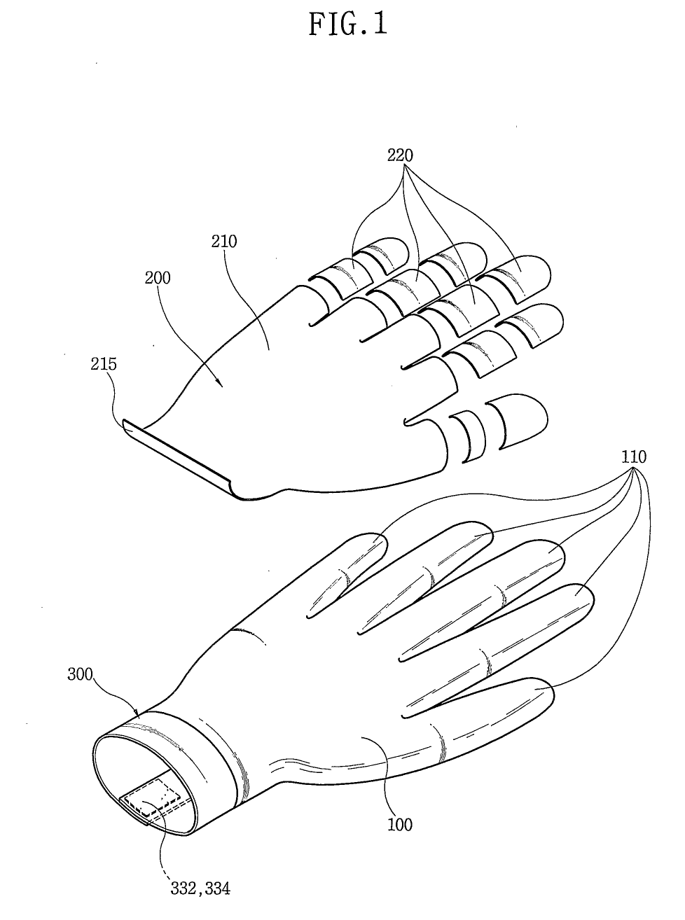

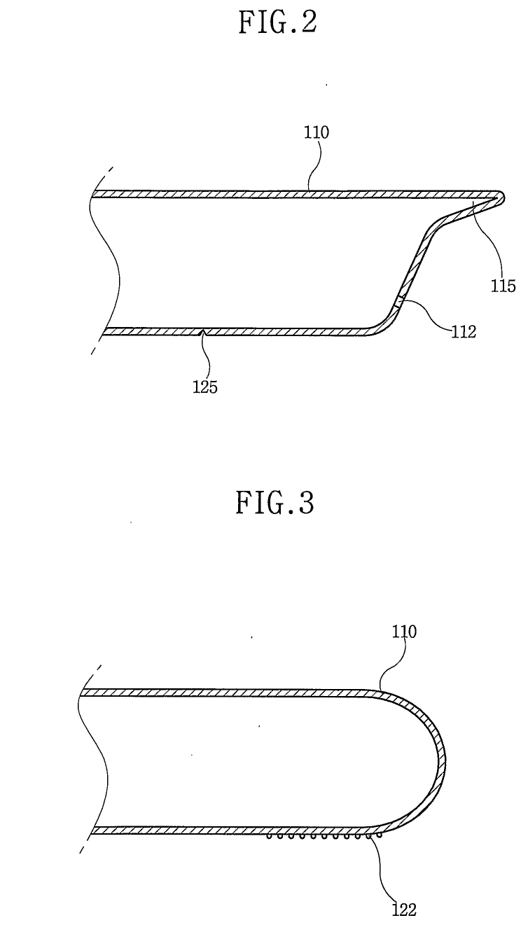

A hand protector for kitchen work according to the first embodiment of the present invention will be described with reference to FIGS. 1 and 2. The hand protector includes an inner unit 100, an outer unit 200 and a band unit 300. The inner unit 100 is designed to have a separate part for each finger and cover the back of the hand. The outer unit 200 is integrally attached to an outer surface of the inner unit 100, and is sufficiently hard for resisting impact from the blade of a kitchen knife. The band unit 300 is integrally provided on an end of the inner unit 100 and surrounds the user's wrist.

In detail, the inner unit 100 directly contacts the user's hand, so that the inner unit 100 has space to receive the user's fingers. More preferably, the inner unit 100 is constructed so that each finger joint may independently move.

That is, notches 125 are provided on the lower surface of the inner unit 100 to correspond to the finger joints, thus allowing the finger joints to be easily bent. Alternatively, portions corresponding to the finger joints may be cut so that inside and outside portions of the inner unit 100 communicate with each other.

Further, a nail insertion part 115 extends from an end of each finger insertion part of the inner unit 100, thus providing space for receiving the nail. Thereby, the upper portion of the inner unit 100 having the nail insertion part 115 is longer than the lower portion of the inner unit 100.

Since the hand protector of this invention is used in a kitchen, water may flow into the inner unit 100. In order to discharge the water to the outside, water drain holes 112 are provided on an end of the inner unit 100.

FIG. 3 shows an inner unit 100 according to a modification of this invention. As shown in the drawing, a plurality of anti-slip protrusions 122 is provided on part of the lower surface of each finger insertion part 110 of the inner unit 100. The anti-slip protrusions 122 prevent food ingredients from slipping out of the user's grasp.

It is preferable that the anti-slip protrusions 122 be made of the same material as the inner unit 100. However, the anti-slip protrusions 122 may be made of a material different from that of the inner unit 100, prior to being integrally attached to the inner unit 100.

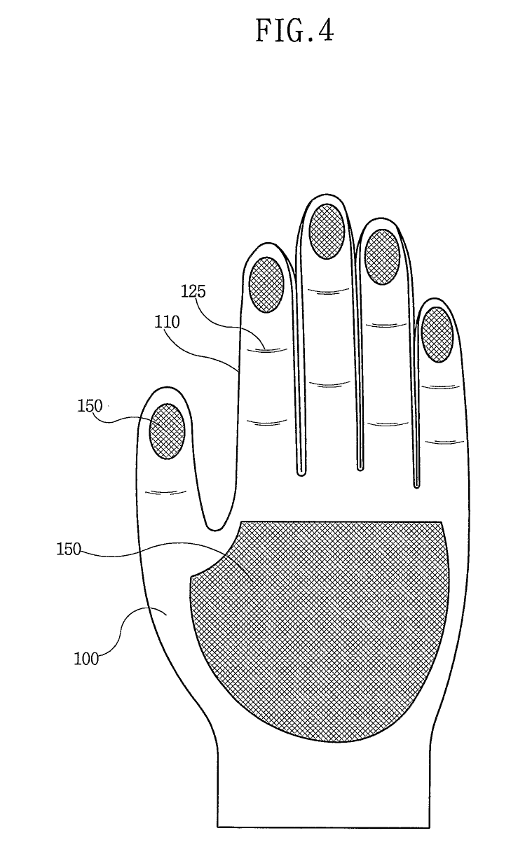

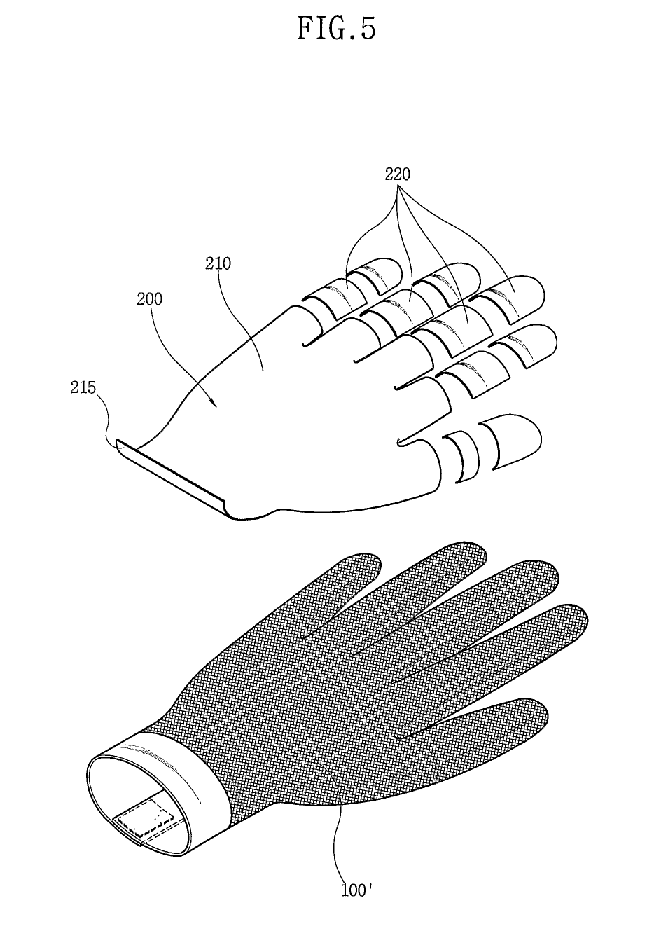

FIG. 4 shows an inner unit, according to another modification of this invention. In this modification, mesh nets 150 are provided on part of the lower surface of the inner unit 100. Further, as shown in FIG. 5, an entire inner unit 100′ may comprise a mesh net. The inner units 100 and 100′ according to the modifications may have a water drainage function and an anti-slip function.

Meanwhile, the outer unit 200 includes an outer hand-back covering part 210 and outer finger covering parts 220. The outer hand-back covering part 210 and the outer finger covering parts 220 contact the back of the hand and the fingers, respectively, such that they do not interfere with the movement of the upper surface of the inner unit 100.

Further, as shown in FIGS. 1 and 5, each outer finger covering part 220 may be divided into a plurality of sections to correspond to finger segments. Each outer finger covering part 220 may have a single structure, as long as the outer finger covering part does not hinder the movement of the fingers.

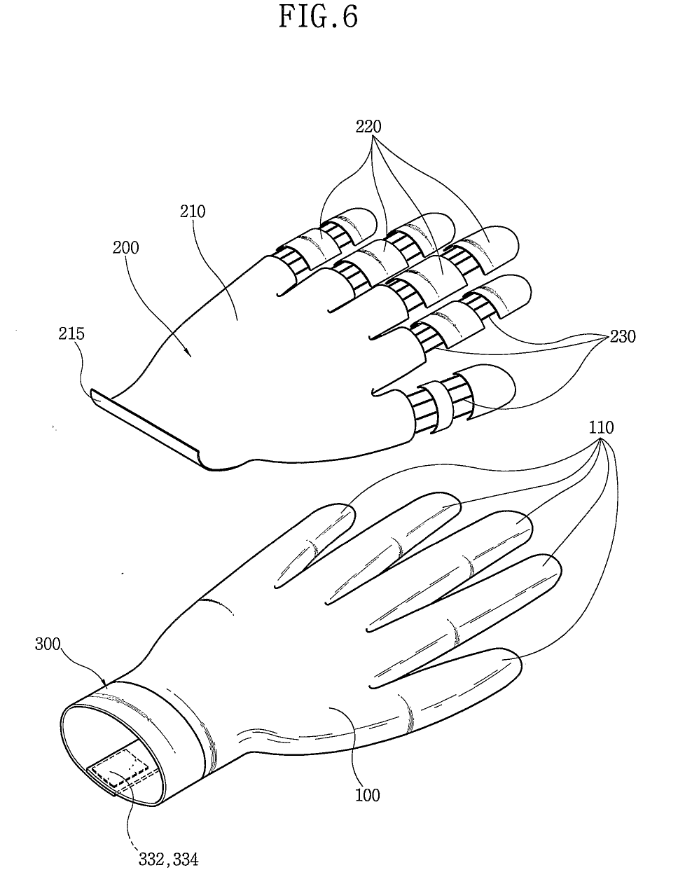

FIG. 6 shows an outer unit 200, according to a modification of this invention. In this modification, the outer hand-back covering part 210 is coupled to the outer finger covering parts 220 via coupling members 230, such as wires or chains.

The inner unit 100 is in direct contact with the user's hand. Thus, in order to ensure unrestricted movement of the hand and good skin health, a material which has excellent elasticity and is harmless to humans is preferred (e.g., SPCTCR is a new material recently approved by the US Food and Drug Administration (FDA) and has properties intermediate between those of plastics and rubber, latex that is natural rubber, synthetic resin, silicone, and others). Further, antibacterial agents, aromatics, and others may be added to the inner unit 100. Meanwhile, since the outer unit 200 must have sufficient hardness, it is preferable that the outer unit 200 be made of metal or plastic having high hardness. However, wood, leather, and other materials may be employed as the outer unit 200, as long as the materials have enough hardness to resist impact from the blade of the kitchen knife.

The outer unit 200 is frequently exposed to water in a kitchen, so the outer unit 200 is more preferably made of titanium, stainless steel, etc. which is resistant to corrosion, has high hardness, and is harmless to humans.

Further, a wrist protecting portion 215 is provided on an end of the wrist side of the outer unit 200, and is bent to protrude upwards. The wrist protecting portion 215 functions to prevent the wrist from being injured due to the slippage of the kitchen knife.

Preferably, the band unit 300 is made of an elastic material (e.g. rubber, synthetic resin, etc.) so that the band unit 300 surrounds the user's wrist and causes the inner unit 100 to be in close contact with the hand. The band unit 300 is constructed as follows. That is, the band unit 300 includes a wrist cover part and both ends extend outwards from both sides of the wrist cover part. Hook and pile pieces 332 and 334 of a Velcro fastener are provided at corresponding positions on respective ends. The hook and pile pieces are detachably attached to each other.

The first embodiment of this invention constructed as described above is operated as follows.

The assembly of the hand protector for kitchen work according to this invention is as follows. That is, the wrist cover part of the band unit 300 is arranged to be in surface contact with an end of the inner unit 100. In such a state, the band unit 300 is attached to the inner unit 200 using an adhesive, such as a bonding agent or silicone. Alternatively, the band unit 300 may be integrated with the inner unit 200 through thermal bonding.

Subsequently, after the outer unit 200 is laid on the upper surface of the inner unit 100, the outer unit 200 is attached to the inner unit 100 to form a single structure using an adhesive, such as silicone.

It is easy to assemble the hand protector in the above-mentioned order. However, the assembling order may be variously changed without being limited to the above-mentioned order, as long as the assembly is easily implemented.

After the assembly of the hand protector has been completed, a user may wear the hand protector on the hand that does not hold the kitchen knife, before he or she operates the kitchen knife in a kitchen for cutting food ingredients. The process of wearing the hand protector is as follows. First, the user puts his or her hand into the inner unit 100 so that fingers are inserted into the inner unit 100. Next the wrist cover part of the band unit 300 is disposed on the wrist. Further, one of both ends of the band unit 300 is wrapped around the wrist. Thereafter, the ends of the band unit 300 are fastened to each other.

When the user is wearing the hand protector, it is possible to easily bend or stretch his or her fingers accommodated in the inner unit 100. Thus, the user can easily press down an object to be cut, that is, food ingredients, so as to hold the food ingredients, prior to cutting the food ingredients. Further, even if the user makes careless mistakes, the outer unit 200, made of a material having high hardness, protects his or her hand from the blade of the kitchen knife.

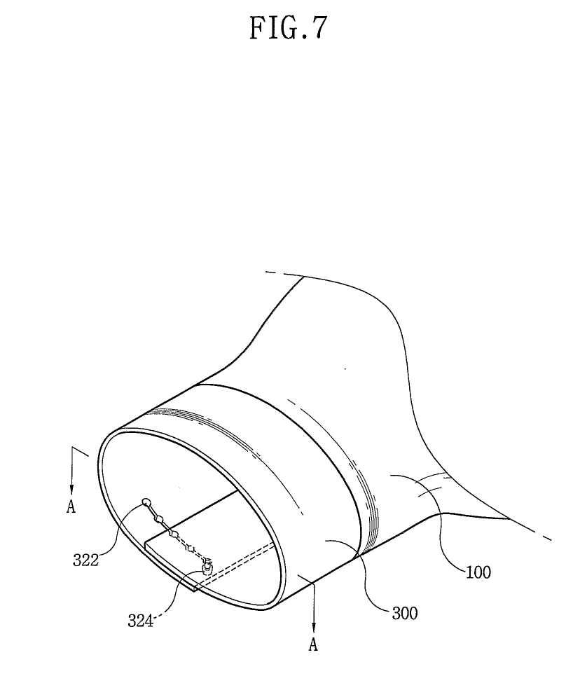

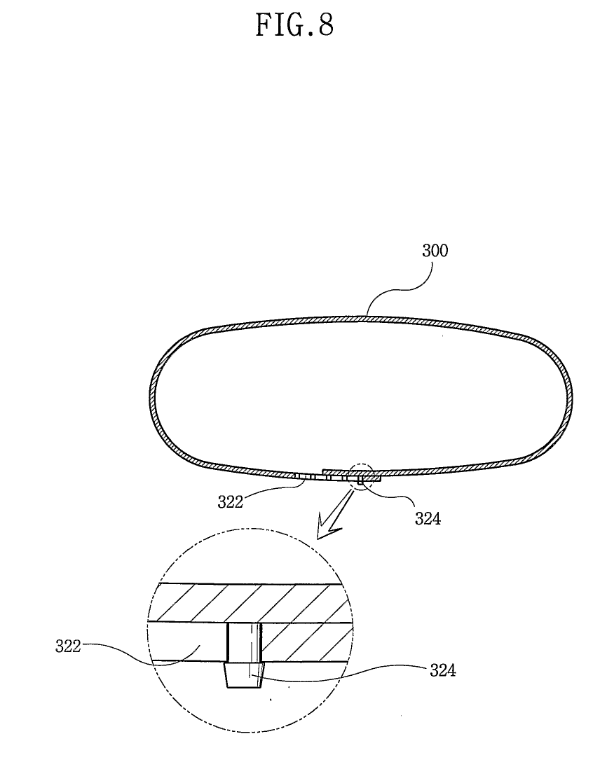

FIG. 7 is a perspective view showing another coupling structure of the band unit, according to the first embodiment of this invention, and FIG. 8 is a sectional view taken along line AA of FIG. 7. The band unit 300 of FIGS. 7 and 8 has a fastening means different from the above-mentioned fastening means. That is, the fastening means of the band unit 300, according to the modification of this invention, includes a locking projection 324 and a plurality of locking holes 322. The locking projection 324 is provided on one of both ends of the band unit 300 to protrude outwards. The locking holes 322 are provided on the other end of the band unit 300, with a locking step provided on an inner surface of each locking hole 322. Thereby, both ends of the band unit 300 are wound around the wrist, and are then fastened to each other using the locking projection and the locking holes.

The locking projection 324 and the locking holes 322 surround outer surfaces of both ends of the band unit 300 in the form of a ring, in addition to adjusting the length of the band unit 300 as desired. Further, the fastening means is constructed so that the locking projection 324 slides in the locking holes 322.

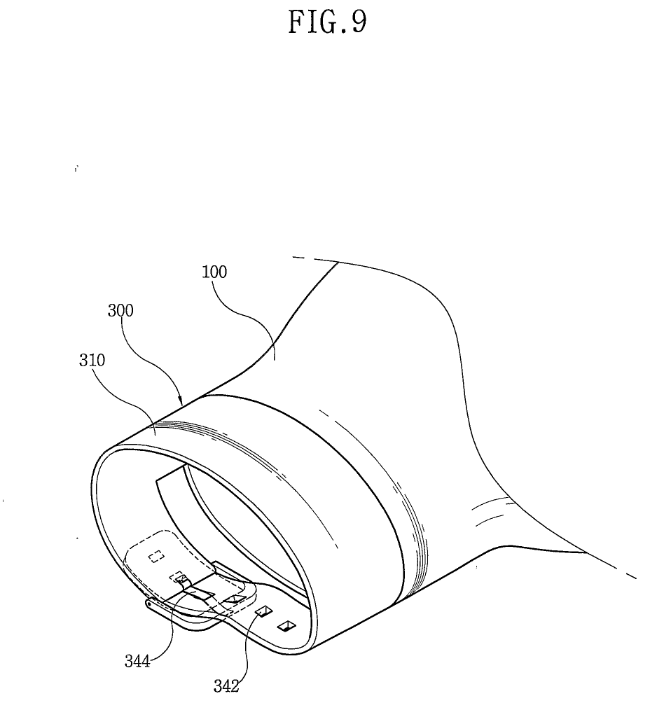

Meanwhile, FIG. 9 is a perspective view showing a still another coupling structure of the band unit, according to the first embodiment of this invention. The band unit 300 of FIG. 9 is different from the above-mentioned band units in that a fastening means provided on both ends of the band unit comprises a belt-type coupling structure which is capable of adjusting the length of the band unit, after both ends of the band unit 300 have been wound around the wrist. The fastening means includes a plurality of punch holes 342 and a fitting tongue 344. The punch holes 342 are formed on one of both ends of the band unit at regular intervals. The fitting tongue 344 is provided on the other end of the band unit and is fitted into the punch holes 342.

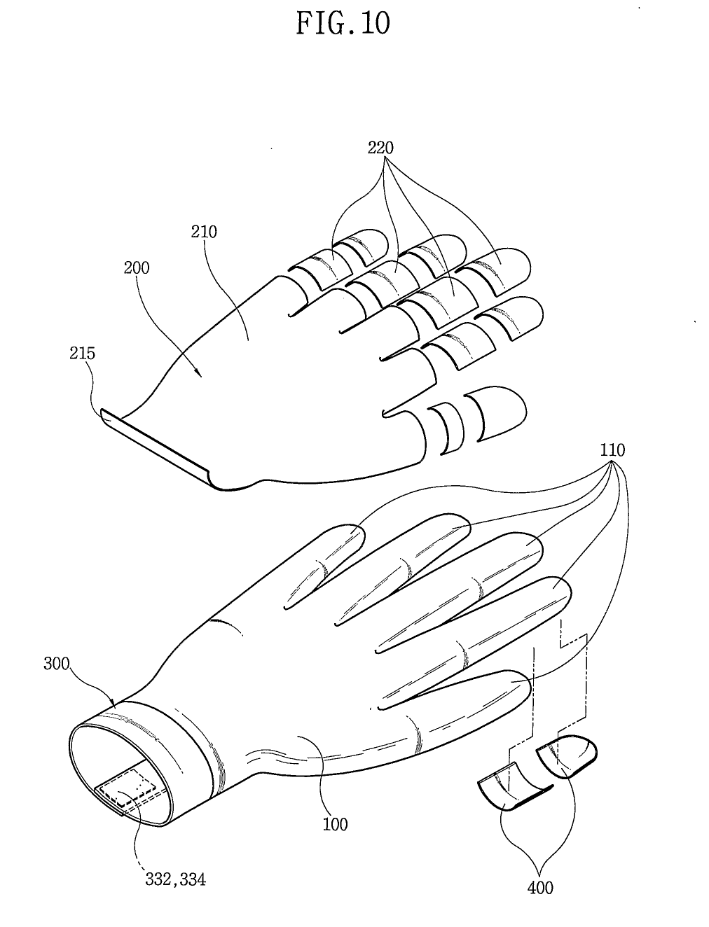

FIG. 10 is a perspective view of an inner unit, according to a further modification of the first embodiment of this invention, with reinforcing pieces attached to the lower surface of the inner unit. As shown in FIG. 10, reinforcing pieces 400 are attached to the lower surface of the inner unit 100, for example, the undersides of the finger insertion parts, using an adhesive, such as a bonding agent or silicone. Further, the reinforcing pieces 400 may be attached to the lower surface of the inner unit 100 through a thermal bonding or an injection. Therefore, the reinforcing pieces 400 additionally reinforce the undersides of the finger insertion parts of the inner unit 100.

### Second Embodiment

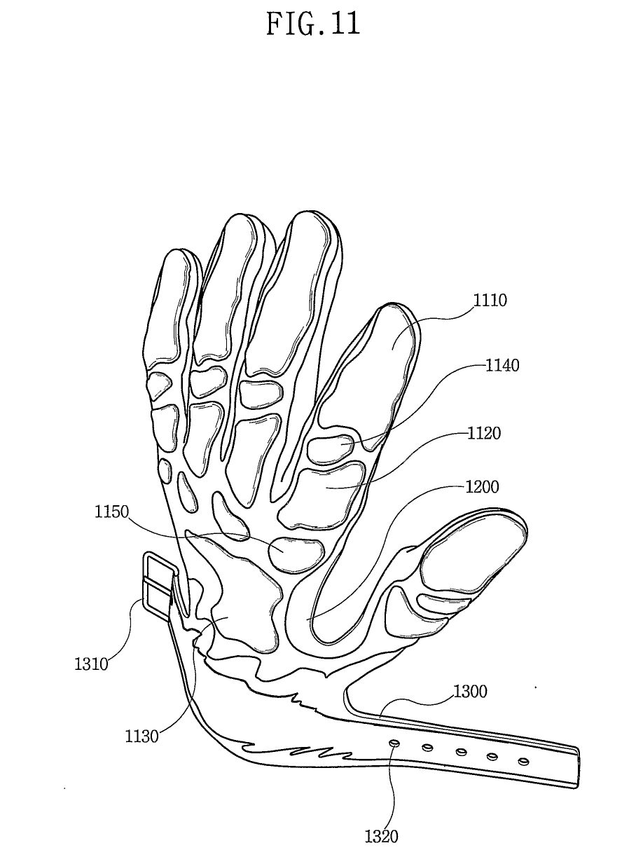

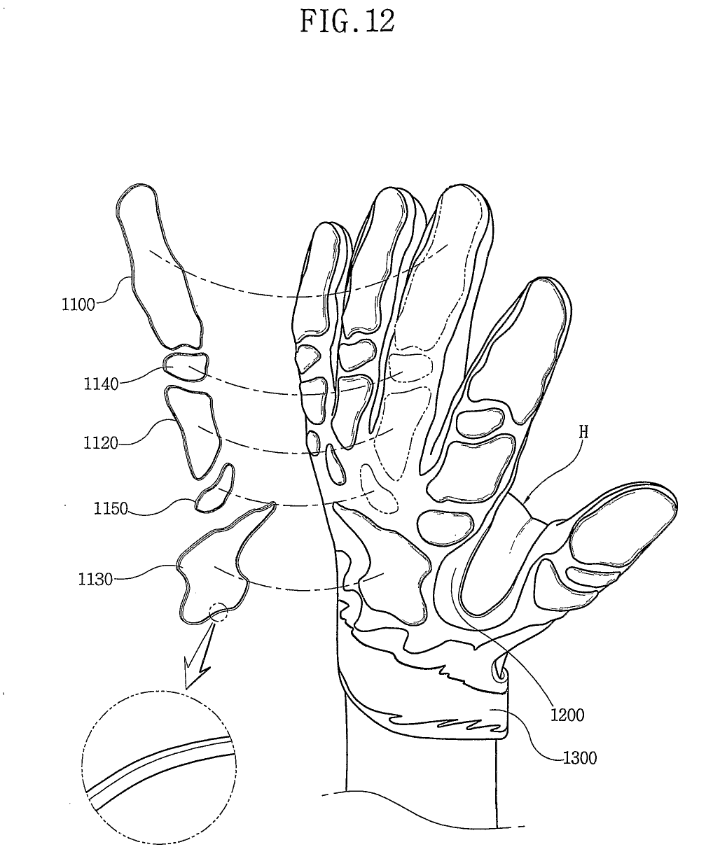

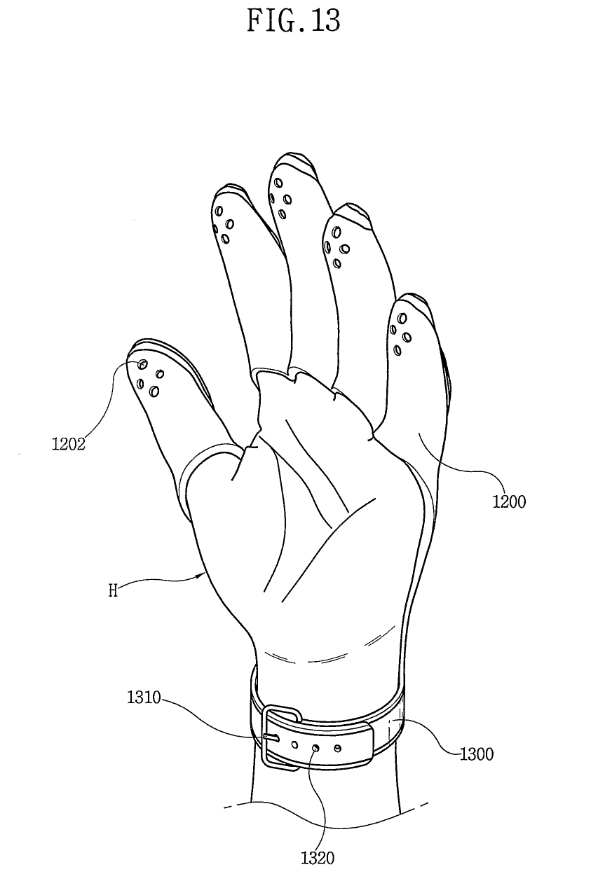

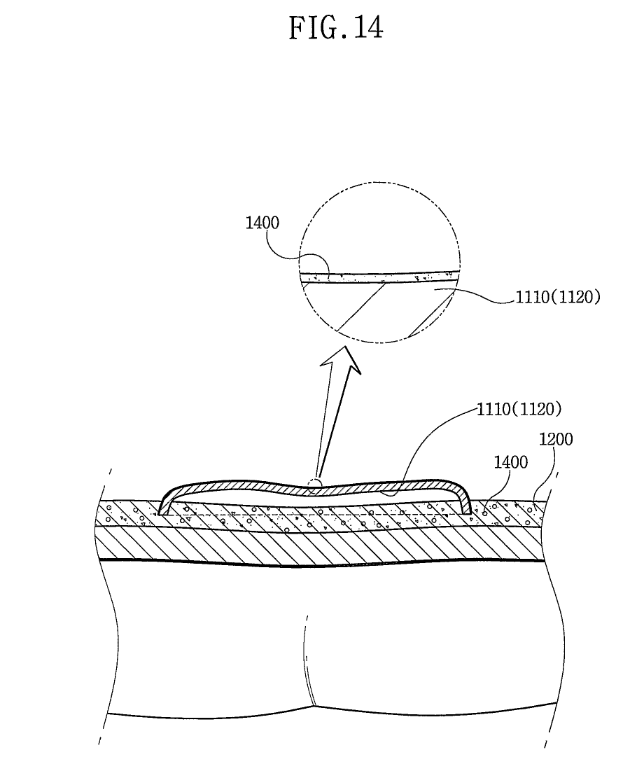

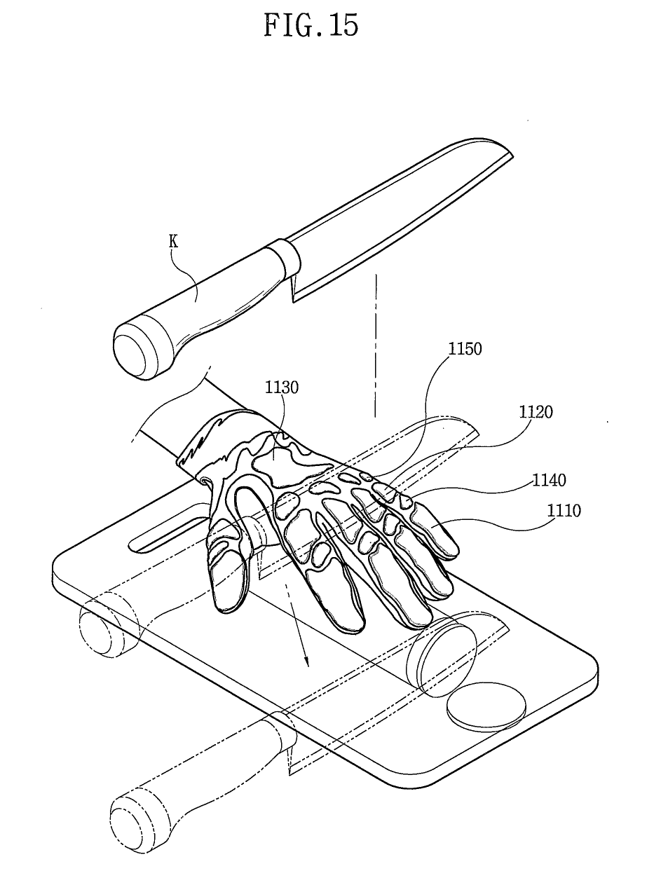

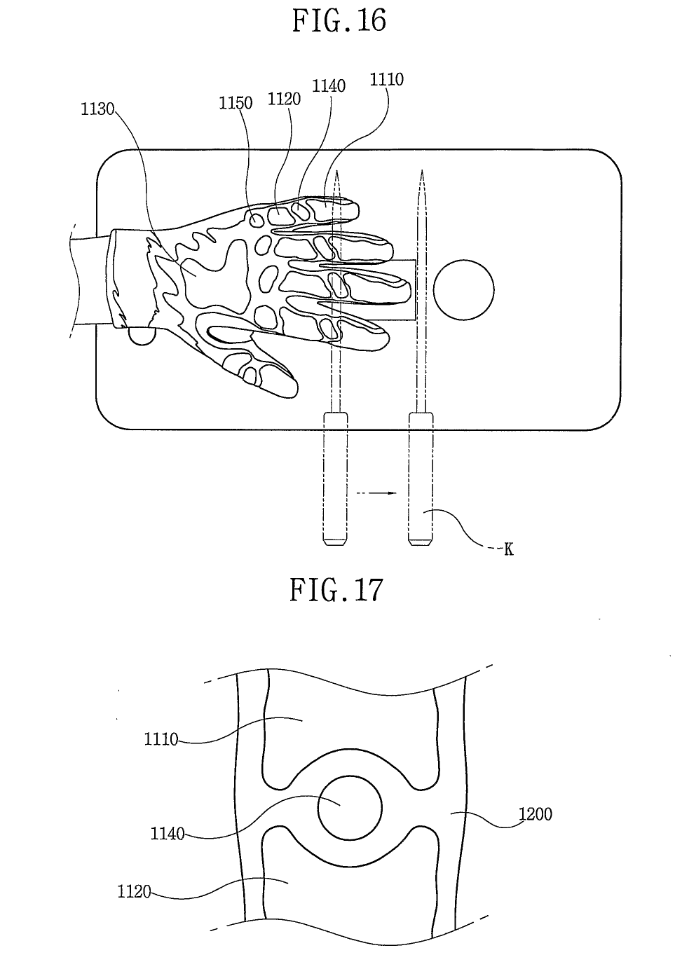

A hand protector for kitchen work according to a second embodiment of this invention will be described with reference to FIGS. 11 to 16. The hand protector includes first and second outer finger covering parts 1110 and 1120 having shapes corresponding to finger segments to cover the outer surfaces of the finger segments. An outer hand-back covering part 1130 is provided at a position adjacent to ends of the first and second outer finger covering parts 1110 and 1120, and has a shape corresponding to the back of the hand to cover the back of the hand. An inner unit 1200 is integrally attached to inner surfaces of the first and second outer finger covering parts 1110 and 1120 and the outer hand-back covering part 1130, and is in direct contact with the back of the hand and the upper surfaces of the fingers. The band unit 1300 is integrally coupled to an end of the inner unit 1200, and surrounds the user's wrist.

In a detailed description, the inner unit 1200 is integrally attached to the inner surfaces of the outer hand-back covering part 1130 and the first and second outer finger covering parts 1110 and 1120, thus integrally coupling the outer hand-back covering part 1130 to the first and second outer finger covering parts 1110 and 1120.

The first and second outer finger covering parts 1110 and 1120 covering the outer surfaces of the finger segments are separated by the finger joints. In order to cover the outer surfaces of the separate finger joints, first and second outer joint covering parts 1140 and 1150 are provided.

Further, ends of the first and second outer finger covering parts 1110 and 1120 are slanted with respect to the lengthwise direction of the finger. That is, the ends of the first and second outer finger covering parts 1110 and 1120 are slanted in a direction inconsistent with a moving direction of the blade of a kitchen knife K. Such a construction prevents the kitchen knife K from passing through gaps between the first and second outer finger covering parts 1110 and 1120 and the first and second outer joint covering parts 1140 and 1150.

If a user is right-handed, the blade of the kitchen knife K moves perpendicularly to the lengthwise direction of the finger or moves diagonally in a direction from the upper end of the left side to the lower end of the right side. Thus, for the right-handed person, the ends of the first and second outer finger covering parts 1110 and 1120 are preferably slanted in a direction inconsistent with the moving direction of the blade of the kitchen knife (K), that is, in a direction from the lower end of the left side to the upper end of the right side, as shown in FIGS. 11 to 16.

Conversely, if a user is left-handed, it is preferable that the ends of the first and second outer finger covering parts 1110 and 1120 be slanted in a direction opposite to that of the first and second outer finger covering parts designed for the right-handed person.

The first and second outer finger covering parts 1110 and 1120, the outer hand-back covering part 1130, and the first and second outer joint covering parts 1140 and 1150 may be made of the same material. Titanium, stainless steel, etc. which have hardness sufficient to protect the user's hand (H) from the blade of the kitchen knife (K) and are harmless to humans are preferred materials. However, without being limited to the above-mentioned materials, wood, leather, and other materials may be used, as long as the materials are hard enough to prevent the hand protector from being damaged by the blade of the kitchen knife.

Further, the inner unit 1200 is made of a material different from the outer parts 1110 to 1150. The inner unit 1200 is in direct contact with the user's hand. Thus, in order to ensure unrestricted movement of the hand and good skin health, a material which has excellent elasticity and is harmless to humans is preferred (e.g., SPCTCR is a new material recently approved by the US FDA and has properties intermediate between those of plastic and rubber, latex that is natural rubber, synthetic resin, silicone, and others).

The inner unit 1200 may comprise a single-layered structure or a multi-layered structure that is made of the same material. In the case of the multi-layered structure, it is possible to add colorants to layers so that the layers have different colors.

The inner unit 1200 may be integrally attached to the inner surfaces of the first and second outer finger covering parts 1110 and 1120 and the outer hand-back covering part 1130, using a special adhesive or the like. Further, the outer hand-back covering part 1130 and the first and second outer finger covering parts 1110 and 1120 may be manufactured through an injection process so that edges of the outer hand-back covering part 1130 and the first and second outer finger covering parts 1110 and 1120 are inserted into the inner unit 1200, during the attaching operation.

That is, the hand protector according to the second embodiment of this invention may be manufactured as follows. After the first and second outer finger covering parts 1110 and 1120 and the outer hand-back covering part 1130 are supported in a metal mold such that they are spaced apart from each other, a liquid inner unit 1200 is applied to the inner surfaces of the first and second outer finger covering parts 1110 and 1120 and the outer hand-back covering part 1130. Thereafter, a solidifying process is performed to provide an integrated hand protector. The hand protector is removed from the metal mold. In this way, the finished hand protector is obtained.

It is preferable that a conventional luminous paint 1400 be added to the liquid inner unit 1200. When the luminous paint 1400 is added as such, the inner unit 1200 emits light in the dark thus ensuring the sight of a user, thereby allowing him or her to safely use the kitchen knife (K) even in a place where indoor illumination is not provided.

The inner unit 1200 is constructed such that the inner unit 1200 has a shape corresponding to the fingers and the back of the hand to cover the outer surfaces of the fingers and the back of the hand. Further, an inside portion of the inner unit 1200 excluding the finger insertion parts is open to afford good air permeation and water drainage.

Further, a plurality of water drain holes 1202 is formed on the inner surface of each finger insertion part of the inner unit 1200, thus allowing water to be smoothly drained while the hand protector is used in a kitchen.

The band unit 1300 is made of an elastic material, and serves to elastically compress and support the user's wrist. In order to fasten both ends of the band unit 1300 to each other a buckle 1310 is provided on one end of the band unit 1300, and a plurality of punch holes 1320 is provided on the other end of the band unit 1300 at regular intervals. The band unit 1300 is not limited to a specific material but is preferably made of a material having elasticity.

Further, both ends of the band unit 1300 are not fastened to each other through the belt fastening method, but may be fastened to each other using a Velcro fastener which is provided on both ends of the band unit 1300.

Unlike the inner unit 1200, the luminous paint 1400 is not added to the outer surface of each outer part but may be applied to form a layered structure.

FIG. 17 shows first and second outer finger covering parts 1110 and 1120, and first outer joint covering parts 1140, according to a modification of the second embodiment. As shown in the drawing, ends of the first and second outer finger covering parts 1110 and 1120 are rounded in a “U” shape, and form a symmetrical arrangement. The first outer joint covering part 1140 has a circular shape, and is provided between the facing ends of the first and second outer finger covering parts 1110 and 1120.

As such, when the facing ends of the first and second outer finger covering parts 1110 and 1120 have a “U” shape to form a symmetrical arrangement, and the first outer joint covering part 1140 has a circular shape, gaps between the first and second outer finger covering parts 1110 and 1120 and the first outer joint covering part 1140 do not have a straight-line shape. Such a construction completely prevents the blade of the kitchen knife (K) from passing through the gaps.

Particularly, such a construction is advantageous in that the hand protector is usable regardless of whether a user is right-handed or left-handed.

Further, it is possible to variously change the shape of the ends of the outer parts 1110 to 1150 including the first and second outer finger covering parts 1110 and 1120.

The operation of the second embodiment of this invention will be described below.

The hand protector for kitchen work according to the second embodiment of this invention, is constructed such that the inner unit 1200 is integrated with the outer parts through an injection process or the like. When the user puts his or her hand into the integrated hand protector such that the fingers and the back of the hand are received in the hand protector, his or her fingers are accommodated in the inner unit 1200, and the back of the hand is covered with the inner unit 1200 and the outer hand-back covering part 1130. Further, the band unit 1300 is wound around the user's wrist, and subsequently the ends of the band unit 1300 are fastened to each other. In this way, the hand protector is worn on the user's hand (H).

Thereafter, the user presses down food ingredients to hold the ingredients. In such a state, the user cuts the ingredients with the kitchen knife. Since the inner unit 1200 has elasticity, the user can bend the finger joints and press down and hold an end of the object to be cut.

Further, the first and second outer finger covering parts 1110 and 1120 provided at positions corresponding to the finger segments are separated from each other. Thus, when the finger joints are bent, the first and second outer finger cover parts can rotate relative to each other while being connected to the extended inner unit 1200.

At this time, the first outer joint covering part 1140, provided between the first and second outer finger covering parts 1110 and 1120, is located on the outer portion of each finger joint. Further, the second outer joint covering part 1150 is located between the second outer finger covering part 1120 and the outer hand-back covering part 1130 that are separated from each other, thus protecting the finger joints from the kitchen knife, even when the fingers are bent.

The hand protector worn on the user's hand prevents the hand from being cut or completely severed by the kitchen knife, while he or she cuts food with the kitchen knife in a kitchen.

Therefore, the hand protector worn on the user's hand covers part of the outer surface of his or her hand. Further, the first and second outer finger covering parts 1110 and 1120 covering the outer surfaces of the fingers are separated from each other. Thus, the hand protector is capable of protecting the outer surface of the user's hand (H), in addition to allowing the fingers to be easily bent, when food ingredients or the like must be held.

### Third Embodiment

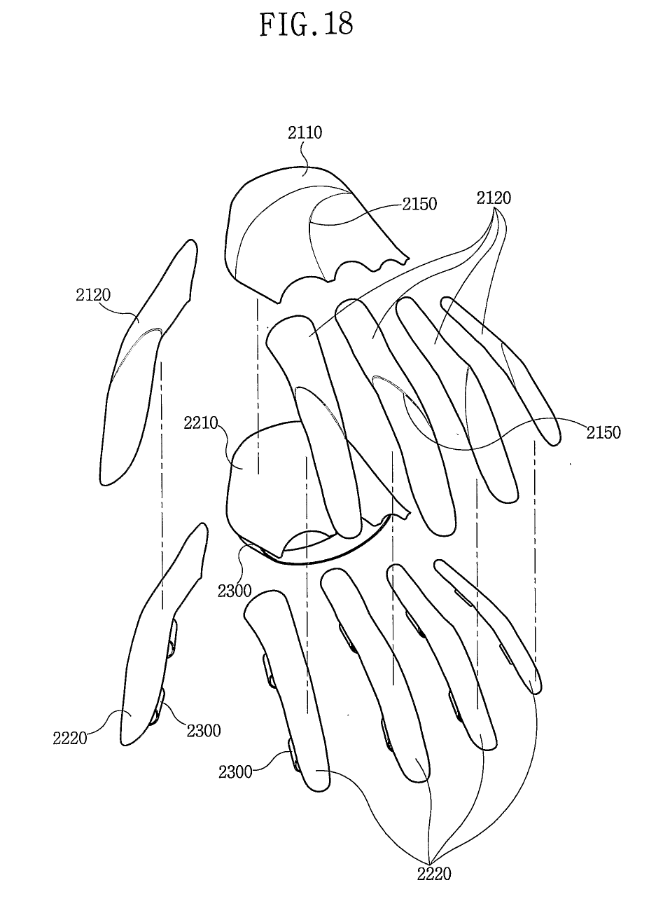

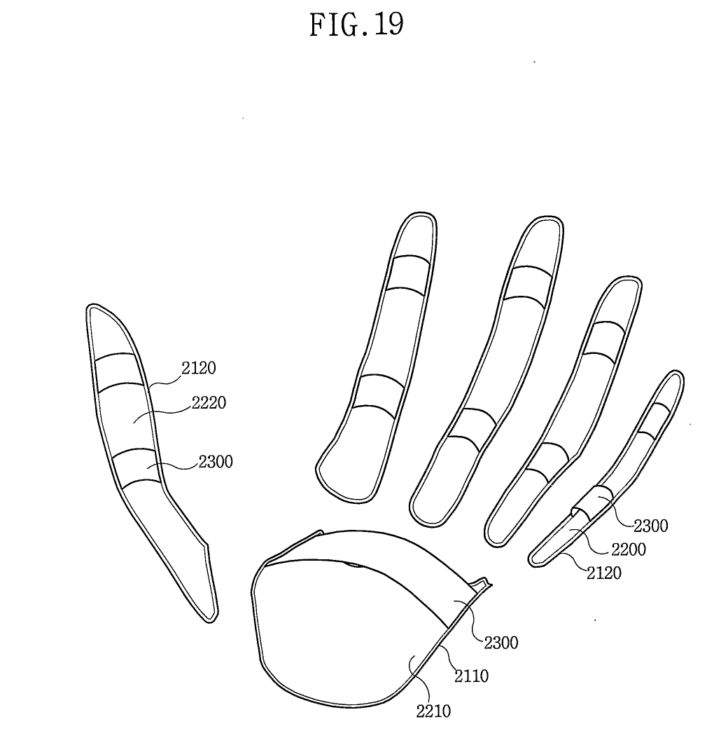

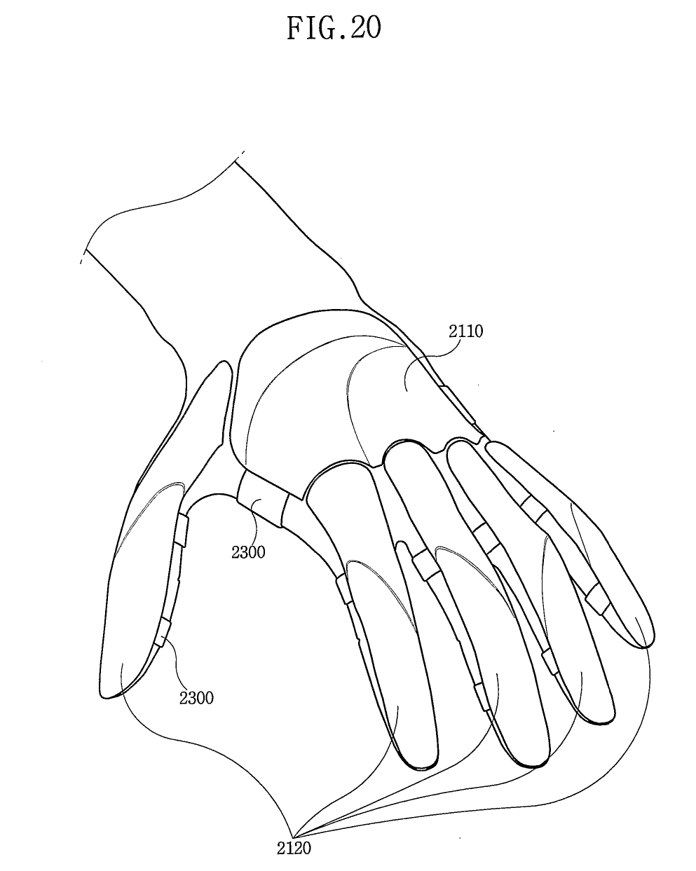

A hand protector for kitchen work according to the third embodiment of this invention, will be described with reference to FIGS. 18 to 20. The hand protector includes outer finger covering parts 2120 having shapes corresponding to fingers to cover the upper portions of the fingers. An outer hand-back covering part 2110 is provided at a position adjacent to the ends of the outer finger covering parts 2120, and has a shape corresponding to the back of the hand to cover the back of the hand. An inner hand-back covering part 2210 and inner finger covering parts 2220 are integrally attached to lower surfaces of the outer hand-back covering part 2110 and the outer finger covering parts 2120, and are in direct contact with the back of the hand and the fingers. Further, band parts 2300 are integrally provided on the inner hand-back covering part 2210 and the inner finger covering parts 2220, and have elasticity to surround the fingers and the back of the hand.

In a detailed description, the inner finger covering parts 2220 are integrally attached to the lower surfaces of the plurality of outer finger covering parts 2120. Further, the inner hand-back covering part 2210 is integrally attached to the lower surface of the outer hand-back covering part 2110.

The outer finger covering parts 2120, the outer hand-back covering part 2110, the inner finger covering parts 2220, and the inner hand-back covering part 2210 are made of different materials. In this case, the outer parts 2110 and 2120 are preferably made of titanium, stainless steel, and others, which are sufficiently hard to protect the user's hand from the blade of the kitchen knife and are harmless to humans.

Further, the inner parts 2210 and 2220 are in direct contact with the user's hand. Thus, in order to ensure unrestricted movement of the hand and healthy skin, a material which has excellent elasticity and is harmless to humans is preferred (e.g., SPCTCR is a new material recently approved by the USFDA and has properties intermediate between those of plastics and rubber, latex that is natural rubber, synthetic resin, silicone, and others).

The band parts 2300 elastically compress and support the fingers and the back of the hand. For example, the band parts 2300 may be made of synthetic rubber having elasticity.

Further, bending parts 2150 are provided on the outer hand-back covering part 2110 and the outer finger covering parts 2120, and have thickness different from other parts so as to ensure unrestricted movement of the back of the hand and the fingers.

The operation of the third embodiment of this invention constructed as described above will be described below.

In the hand protector for kitchen work according to the third embodiment of this invention, the inner finger covering parts 2220 are attached to the lower surfaces of the outer finger covering parts 2120 using an adhesive or the like. The inner hand-back covering part 2210 is integrally attached to the lower surface of the outer hand-back covering part 2110. Afterwards, the outer finger covering parts 2120 and the outer hand-back covering part 2110 are fastened to the fingers and the back of the hand, respectively, using the band parts 2300. Therefore, the assembly of the hand protector is completed.

In this case, the band parts 2300 are made of an elastic material. The band parts 2300 are pulled downwards to be spaced apart from the inner finger covering parts 2220 and the inner hand-back covering part 2210. In such a state, the user's hand is inserted into the hand protector. At this time, the band parts 2300 surround part of the user's hand to secure the hand protector to the hand. In this way, the hand protector 2100 is worn on the user's hand.

The hand protector 2100 worn on the user's hand prevents the hand from being cut or completely severed by a kitchen knife, while he or she cuts food using the kitchen knife in a kitchen. That is, the hand protector 2100 functions to protect the user's hand from injury.

In this case, the hand protector worn on the user's hand covers only part of the upper surface of the hand, so that the hand protector does not hinder the user from holding food ingredients using the undersides of the fingers or the back of the hand.

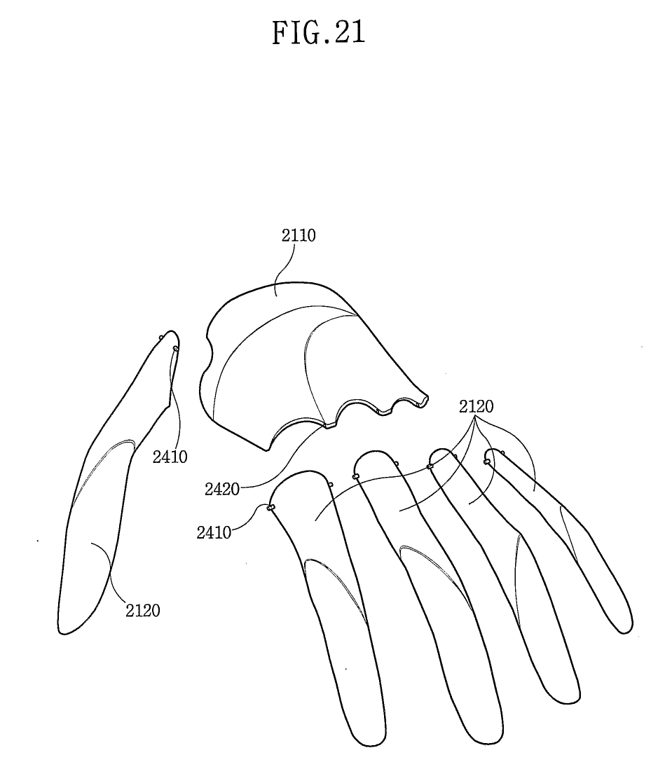

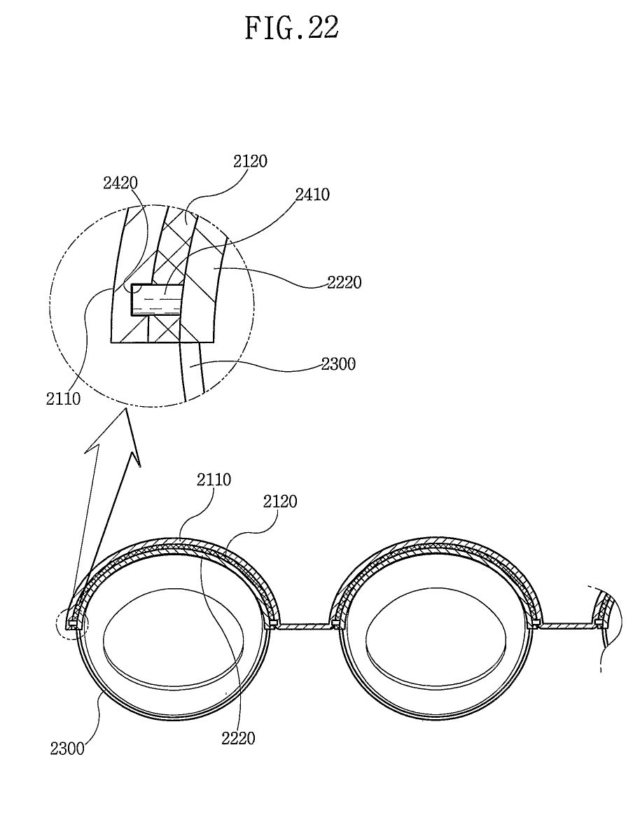

FIGS. 21 and 22 show an outer hand-back covering part and outer finger covering parts, according to a modification of the third embodiment. As shown in the drawings, the outer finger covering parts 2120 are constructed to be detachably attached to an end of the outer hand-back covering parts 2110 via a fastening means.

Each outer finger covering part 2120 is hinged to the outer hand-back covering part 2110 by the fastening means. The fastening means includes hinge shafts 2410 which protrude outwards from both sides of each outer finger covering part 2120, and hinge holes 2420 which are provided on the end of the outer hand-back covering part 2110 coupled to the ends of the outer finger covering parts 2120 and correspond to the hinge shafts 2410.

That is, the hinge shafts 2410 provided on both sides of the end of each outer finger covering part 2120 are fitted into the corresponding hinge holes 2420 provided on the end of the outer hand-back covering part 2110, so that the outer finger covering parts 2120 are rotatably hinged to the outer hand-back covering part 2110.

Such a construction allows each outer finger covering part 2120 to be selectively removed from the hand protector for the user's convenience.

Alternatively, the fastening means of FIGS. 21 and 22 may be constructed differently. That is, the hinge shafts 2410 may be provided on the end of the outer hand-back covering part 2110, and the hinge holes 2420 may be provided on both sides of the end of each outer finger covering part 2120.

### Fourth Embodiment

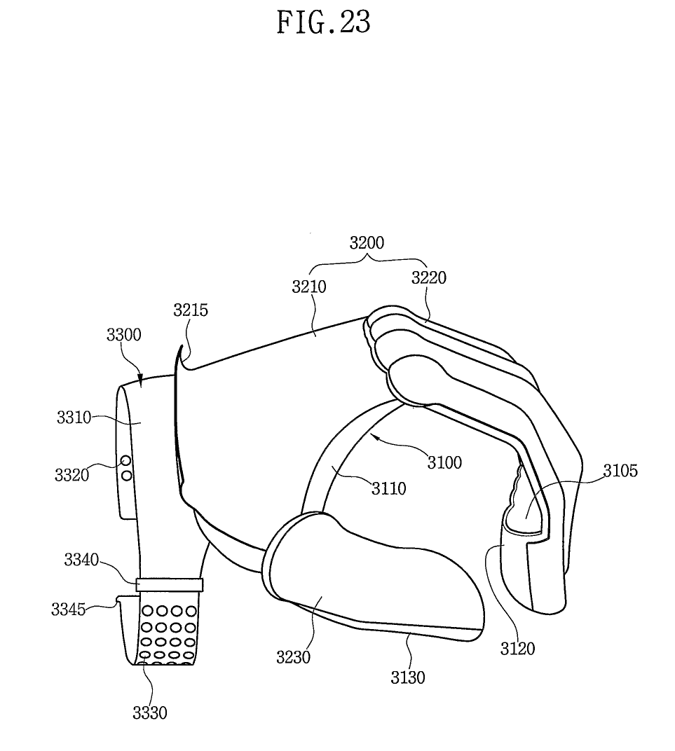

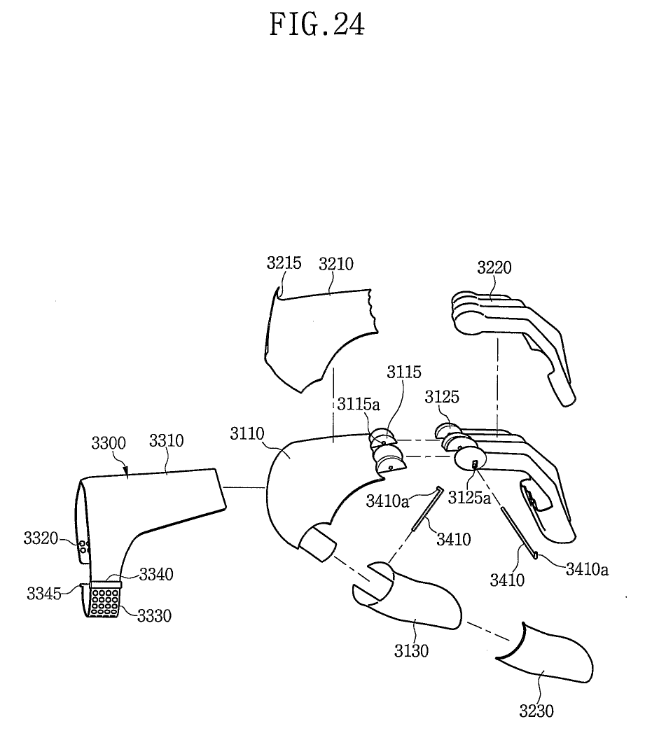

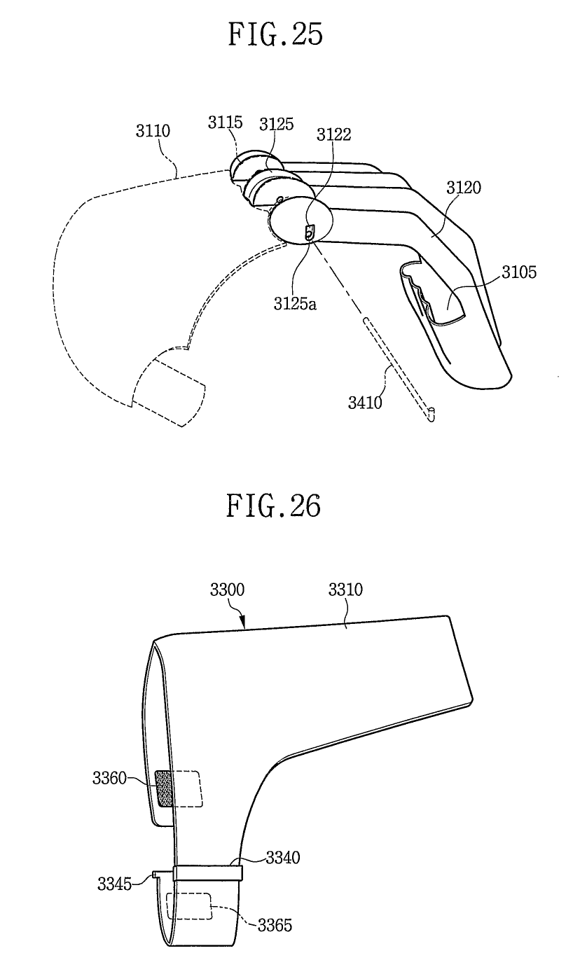

A hand protector for kitchen work according to the fourth embodiment of this invention, will be described with reference to FIGS. 23 to 25. The hand protector includes an inner unit 3100, an outer unit 3200, and a band unit 3300. The inner unit 3100 has a shape corresponding to the fingers and the back of the hand to cover the fingers and the back of the hand. A hand-back covering part of the inner unit 3100 is coupled to finger insertion parts of the inner unit 3100 via coupling pins 3410. The outer unit 3200 is integrally attached to the outer surface of the inner unit 3100 using silicone. The band unit 3300 is integrally attached to an end of the inner unit 3100 using silicone, and surrounds the wrist with both ends of the band unit 3300 being detachably attached to each other.

In a detailed description, the inner unit 3100 includes first second, and third cover parts 3110, 3120 and 3130. The first cover part 3110 has a shape corresponding to the back of the hand to cover the back of the hand. The second cover part 3120 is rotatably coupled to an end of the first cover part 3110 using the coupling pin 3410, and is shaped to cover the fingers except for the thumb. The third cover part 3130 is rotatably coupled to an end of the first cover part 3110 using the coupling pin 3410, and covers the thumb.

In this case, the lower surface of the inner unit 3100 is in direct contact with the user's hand. Thus, in order to ensure unrestricted movement of the hand and healthy skin, a material which has excellent elasticity and is harmless to humans is preferred (e.g., SPCTCR is a new material approved recently by the USFDA and has properties intermediate between those of plastics and rubber, latex that is natural rubber, synthetic resin, silicone, and others).

Further, the outer unit 3200 includes first, second, and third cover parts 3210, 3220, and 3230 having shapes corresponding to the first, second, and third cover parts 3110, 3120, and 3130 of the inner unit 3100. A wrist protecting portion 3215 is provided on an end of the wrist side of the outer unit 3200, and is bent to protrude upwards. The wrist protecting portion 3215 prevents the user's wrist from being injured if the kitchen knife slips.

Preferably, the outer unit 3200 is made of titanium, stainless steel, or another material having sufficient hardness to protect the user's hand from the blade of the kitchen knife, and is harmless to humans.

Meanwhile, each coupling pin 3410, rotatably coupling the first and second cover parts 3110 and 3120 to each other, has a rod shape, with an end of the coupling pin 3410 bent to form a bent part 3410a.

Further, a plurality of fitting parts 3115 and 3125 is provided on the first and second cover parts 3110 and 3120 to engage with each other. In order to pass the coupling pin 3410 through the fitting parts 3115 and 3125, which are aligned in a row, fitting holes 3115a and 3125a are formed on the fitting parts 3115 and 3125, respectively. The outermost fitting part 3115, 3125 has a stop hole 3122. The stop hole 3122 is formed on the outside of the fitting hole 3125a to receive the bent part 3410a of the coupling pin 3410, thus preventing the inserted coupling pin 3410 from undesirably rotating.

The third cover part 3130 is provided at a position spaced apart from the junction of the first and second cover parts 3110 and 3120. The third cover part 3130 is rotatably coupled to the first cover part 3110 via the coupling pin 3410, and covers the thumb.

Preferably, the band unit 3300 is made of an elastic material (e.g. rubber, synthetic resin, etc.) to surround the user's wrist and allow the inner unit 3100 to be in close contact with the wrist. The band unit 3300 includes a wrist cover part 3310 and both ends extending outwards from both sides of the wrist cover part 3310. In order to fasten both ends of the band unit 3300 surrounding the wrist, corresponding concave and convex parts 3320 and 3330 are provided on both ends of the band unit 3300. Further, a fastening loop 3340 and a loop stopper 3345 are provided to fasten both ends of the band unit 3300 to each other.

The fastening loop 3340 is provided to surround both ends of the band unit 3300 in the form of a ring. One end protrudes outwards in a lateral direction, thus the loop stopper 3345 is provided.

The operation of the fourth embodiment of this invention constructed as described above is as follows.

The hand protector for kitchen work according to this invention, is assembled as follows. That is, the wrist cover part 3310 of the band unit 3300 is disposed to be in surface contact with the lower surface of the first cover part 3110 of the inner unit 3100. In such a state, the wrist cover part 3310 is integrally attached to the lower surface of the first cover part 3110 using an adhesive, such as silicone. The third cover part 130 is rotatably coupled to an end of the first cover part 3110 using the coupling pin 3410.

Subsequently, the second cover part 3120 is placed to engage with the fitting parts of the first cover part 3110. After the fitting holes 3115a and 3125a of the first and second cover parts are aligned in a row, the coupling pin 3410 is inserted into the fitting holes. Thus, the second cover part is rotatably coupled to the first cover part.

Next, the first cover part 3210 of the outer unit 3200 is placed above the first cover part 3110 of the inner unit 3100, and thereafter the first cover part 3210 is integrally attached to the first cover part 3110 using silicone or the like. The second and third cover parts 3220 and 3230 are integrally attached to the upper surfaces of the second and third cover parts 3120 and 3130, respectively.

When the fitting holes 3115a and 3125a are aligned in a row, the coupling pin 3410 is fitted into the fitting holes. In order to prevent the coupling pin 3410 from idly rotating, the bent part 3410a of the coupling pin 3410 is received in the stop hole 3122. Thereby, the assembling process is completed.

It is easy to assemble the hand protector in the above-mentioned order. But, the assembling order may be variously changed without being limited to the above-mentioned order, as long as the assembly is easily implemented.

After the assembly of the hand protector has been completed, a user wears the hand protector on the hand that does not hold the kitchen knife, before the user operates the kitchen knife in a kitchen for cutting food ingredients. The process of wearing the hand protector is as follows. First, the user puts his or her hand into the hand protector so that the fingers are accommodated in a finger holding part 3105 of the second cover part 3120. Next, the wrist cover part 3310 of the band unit 3300 is disposed around the user's wrist. Further, one of both ends of the band unit 3300 wraps around the user's wrist. The fastening loop 3340 is stopped by the loop stopper 3345, and the concave and convex parts 3320 and 3330 are coupled to each other through a force-fitting method.

Thus, the third cover part 3130 is positioned on the thumb, and the first and second cover parts 3110 and 3120 are positioned on fingers except for the thumb. Further, distal segments of the fingers excluding the thumb are held in the finger holding part 3105 defined in an end of the second cover part 3120.

After the user has worn the hand protector as such, part of an object to be cut, that is, food ingredients, are pressed down and held by the end of the second cover part 3120. Even though the user makes careless mistakes, the outer unit 3200 made of a steel material protects the user's hand from the blade of the kitchen knife.

FIG. 26 shows another band unit. The band unit 3300 of FIG. 26 is different from the band unit of FIGS. 23 to 25 in that the concave and convex parts engaging with each other through a force-fitting method are not provided on ends of the band unit 3300, and instead, pile and hook pieces 3360 and 3365 of a Velcro fastener are provided on both ends of the band unit 3300.

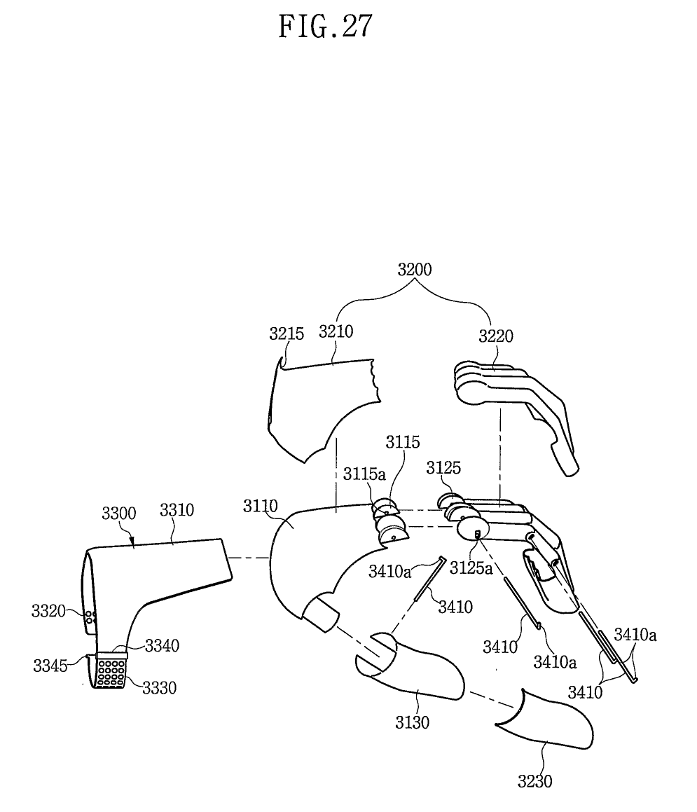

FIG. 27 shows a second cover part of the inner unit, according to a modification of the fourth embodiment. The second cover part 3120 of the inner unit 3100 of FIG. 27 is constructed so that all finger joint parts are coupled to each other using coupling pins 3410, unlike the second cover part which is constructed so that the coupling pin 3410 is provided only at a junction between the first cover part 3100 and the second cover part 3120.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A hand protector for kitchen work, comprising:
an outer hand-back covering part having a shape corresponding to a back of a hand;
a plurality of outer finger covering parts having shapes corresponding to respective fingers; and
an inner unit attached to inner surfaces of the outer hand-back covering part and the outer finger covering parts, the inner unit being constructed so that the fingers may be inserted into the inner unit, and so as to cover the back of the hand.

2. The hand protector according to claim 1, further comprising:
a band unit coupled to an end of the inner unit, and wound around a wrist.

3. The hand protector according to claim 1, wherein each of the outer finger covering parts is divided into a plurality of sections corresponding to finger segments.

4. The hand protector according to claim 1, wherein the inner unit has a shape of a glove, so that the back of the hand is covered with the inner unit and the fingers are inserted into the inner unit.

5. The hand protector according to claim 1, wherein an anti-slip protrusion is provided on a lower surface of the inner unit to hold an object to be cut.

6. The hand protector according to claim 1, wherein a wrist protecting portion is provided on an end of the outer hand-back covering part thus preventing a blade of a kitchen knife from slipping towards the wrist.

7. The hand protector according to claim 1, wherein the inner unit is flexible, with a notch formed on the lower surface of the inner unit to be positioned between neighboring finger segments, thus allowing each of finger joints to be easily bent.

8. The hand protector according to claim 1, wherein a reinforcing piece is integrally attached to a predetermined portion of the lower surface of the inner unit.

9. The hand protector according to claim 1, wherein the inner unit comprises:
at least one water drain hole provided at a finger insertion part of the inner unit.

10. The hand protector according to claim 1, wherein the inner unit comprises:
a mesh net provided on part of the lower surface of the inner unit.

11. The hand protector according to claim 1, wherein the entire inner unit comprises a mesh net.

12. The hand protector according to claim 1, wherein the inner unit comprises:
a nail insertion part provided at an end of the finger insertion part of the inner unit to receive a nail therein.

13. The hand protector according to claim 1 or 3, wherein the outer hand-back covering part is coupled to the outer finger covering parts via coupling members.

14. The hand protector according to claim 1, wherein the band unit comprises on both ends thereof hook and pile pieces of a Velcro fastener, thus allowing the ends to be detachably attached to each other.

15. The hand protector according to claim 3, further comprising:
a plurality of outer joint covering parts provided to correspond to the finger joints, with inner surfaces of the outer joint covering parts attached to the inner unit.

16. The hand protector according to claim 15, wherein neighboring sections of each of the outer finger covering parts have “U”-shaped ends such that the ends form a symmetrical arrangement with respect to an associated finger joint, and
each of the outer joint covering parts is located between facing ends of the neighboring sections of each of the outer finger covering parts.

17. The hand protector according to any one of claims 1, 3 or 15, wherein an end of each of the outer covering parts is slanted with respect to a lengthwise direction of the fingers.

18. The hand protector according to any one of claims 1, 3 or 15, wherein each of the outer parts is made of titanium.

19. The hand protector according to any one of claims 1, 3 or 15, wherein luminous paint is applied to an outer surface of each of the outer parts.

20. The hand protector according to any one of claims 1, 3 or IS, wherein the inner unit has a shape of a glove so that the back of the hand is covered with the inner unit and the fingers are inserted into the inner unit, with part of the inner unit corresponding to a palm being open to enhance air permeation and water drainage.

21. The hand protector according to claim 1, wherein a liquid luminous paint is added to the inner unit.

22. The hand protector according to claim 1, wherein the inner unit comprises:
an inner hand-back covering part to cover the back of the hand; and
a plurality of inner finger covering parts to cover respective fingers.

23. The hand protector according to claim 22, wherein the inner hand-back covering part and the inner finger covering parts are secured to the back of the hand and the fingers via band parts.

24. The hand protector according to claim 1 or 22, wherein each of the outer finger covering parts and the outer hand-back covering part comprises fastening means, the fastening means comprising:
a hinge shaft provided either on an end of each of the outer finger covering parts or on an end of the outer hand-back covering part; and
a hinge hole provided on a remainder of the end of each of the outer finger covering parts or the end of the outer hand-back covering part, and corresponding to the hinge shaft.

25. The hand protector according to claim 1, wherein the inner unit comprises on an end thereof a finger holding part, and has a shape corresponding the back of the hand and the fingers to contact the back of the hand and the fingers, the inner unit being assembled via a coupling pin such that at least part of the inner unit is rotatable.

26. The hand protector according to claim 25, wherein the inner unit comprises:
an inner hand-back covering part to cover the back of the hand; and
a plurality of inner finger covering parts to cover respective fingers, wherein each of the inner finger covering parts is divided into a plurality of sections to correspond to finger segments, and the inner hand-back covering part and each of the inner finger covering parts are rotatably coupled to each other using the coupling pin, and the sections of each of the inner finger covering parts are rotatably coupled to each other using the coupling pin.

27. The hand protector according to claim 25, further comprising:
a band unit coupled to an end of the inner unit and wound around the wrist.
